(19) United States
(12) Patent Application Publication
(10) Pub. No.: US 2006/0199573 A1
(43) Pub. Date: Sep. 7, 2006

(54) MOBILE UNIT AND METHOD FOR EFFICIENTLY ESTABLISHING A MULTI-PARTY CALL

(76) Inventor: Yu-Sheng Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/164,589

(22) Filed: Nov. 29, 2005

(30) Foreign Application Priority Data
Dec. 2, 2004 (TW) 093137253

(51) Int. Cl. H04M 3/42

(52) U.S. Cl. 455/416

(57) ABSTRACT

A method applied to a mobile unit for establishing a multi-party call. The mobile unit is wirelessly coupled to a wireless base station, and the wireless base station is further coupled to a telecommunications network. The method includes setting up a telephone directory having a first number corresponding to a first communication unit coupled to the telecommunications network and a second number corresponding to a second communication unit coupled to the telecommunications network, sequentially dialing numbers in the telephone directory for making a first call to the first communication unit, wherein if the first call is successfully established, the first call is held, making a second call to the second communication unit, and connecting the first call and the second call for establishing the multi-party call if the second call is successfully established.

### BACKGROUND OF THE INVENTION

1. Field of the Invention

The present invention relates to a mobile unit and method, and more particularly, to a mobile unit and method for efficiently establishing a multi-party call.

2. Description of the Prior Art

Mobile Communication becomes one of the fastest growing industries in recent years, resulting in a broad range of new mobile communication technologies being developed. For example, telecommunication systems of mobile phones such as Global System for Mobile communication (GSM) and Personal Handy-phone System (PHS) are widely used in industries. Generally, each kind of telecommunications system supports a multi-party call function. ETSI (European Telecommunications Standards Institute) has defined the detail establishing process and operation mechanism of the multi-party call in technical specifications TS 02.84 and TS 03.84. Therefore, the multi-party call function can be described as applied to a prior art GSM.

Please refer to FIG. 1. FIG. 1 is a flowchart describing a prior method of establishing a multi-party call of a mobile unit such as a mobile phone. Before the flowchart is performed, several telephone numbers are registered in a telephone directory of the mobile unit. The telephone directory has a first number and a second number. The first number corresponds to a first communication unit and the second number corresponds to a second communication unit. The flowchart includes the following steps:

Step 102: Look up the first number and establish a first call according to the first number. It can be looked up by the telephone directory in the mobile phone or keying in the telephone number directly if the telephone number is already known.

Step 108: Is the first call established successfully? If yes, go to step 110. If no, go to step 109.

Step 109: The user decide whether the user want to dial the second number. If yes, go to step 114. If no, go to step 102.

Step 110: Hold the first call.

Step 112: Is the second call established successfully already? If yes, go to step 126. If no, go to step 114.

Step 114: Look up the second number and establish a second call according to the second number.

Step 118: Is the second call established successfully? If yes, go to step 122. If no, go to step 120.

Step 120: The user decide whether the user want to dial the first number? If yes, return to step 102. If no, return to step 114.

Step 122: Is the first call established successfully? If yes, go to step 126. If no, go to step 124.

Step 124: Hold the second call and return to step 102.

Step 126: Connect the first and second calls to establish a multi-party call.

The prior art multi-party call in FIG. 1 becomes difficult in using. Many and complicated steps make users reluctant to use the function. This results in the prior multi-party call function being largely unapplied in daily life. The complicated steps mean the time taken to establish a multi-party call is long, particularly if a user needs to look up telephone numbers. This long establishing time of the multi-party call results in users having to be put on hold for a substantial time while connection with other users is attempted; they may become frustrated and disconnect the call. In other words, there are multiple problems preventing the user from setting up a multi party call. Additionally, if the original user forgets to first put on hold the successfully established calls before attempting to establish the next call, then the other users whose calls are already successfully established will have to listen to a series of DTMF tones, resulting in further inconvenience.

### SUMMARY OF THE INVENTION

One objective of the present invention is therefore to provide a mobile unit and method for establishing a multi-party call, to solve the above-mentioned problem.

According to an exemplary embodiment of the claimed invention, a mobile unit is disclosed for establishing a multi-party call. The mobile unit comprises a memory unit for storing a telephone directory, wherein the telephone directory records at least a first number of a first communication unit and a second number of a second communication unit; and a microcontroller coupled to the memory unit for sequentially dialing numbers in the telephone directory in order to establish a first call with the first communication unit and establish a second call with the second communication unit; wherein if the first and second calls are successfully established, the microcontroller requires the telecommunications network to hold the first call and connects the first and second calls to establish the multi-party call.

According to another exemplary embodiment of the claimed invention, a method is disclosed for establishing a multi-party call. The method comprises the following steps: establishing a telephone directory, wherein the telephone directory at least comprises a first number and a second number, the first number corresponding to a first communication unit, the second number corresponding to a second communication unit, and the first and second communication units connect to the telecommunications network; sequentially dialing numbers in the telephone directory in order to establish a first call to the first communication unit, wherein if the first call is successfully established, the first call is held; establishing a second call to the second communication unit; and connecting the first and second calls for establishing the multi-party call if the second call is successfully established.

The present invention related to a mobile unit and a method for efficiently establishing a multi-party call in the telecommunications network. The microcontroller of the mobile unit sequentially dials numbers in the telephone directory in the mobile unit, establishes, connects and holds the call. After the last call is successfully established, connected and held, full establishment of the multi party call is completed. The mobile unit further comprises a man-machine interface (MMI). The user can send an interrupt message actively through the MMI to make the microcontroller stop attempting to establish a call. Because the present invention mobile unit and method for efficiently establishing a multi-party call can actively establish the multi-party call rather than the user establishing it himself, inconvenience to the user is greatly reduced and the multi party call function can be more widely used in daily life.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a flowchart describing a prior method for establishing a multi-party call of a mobile phone.

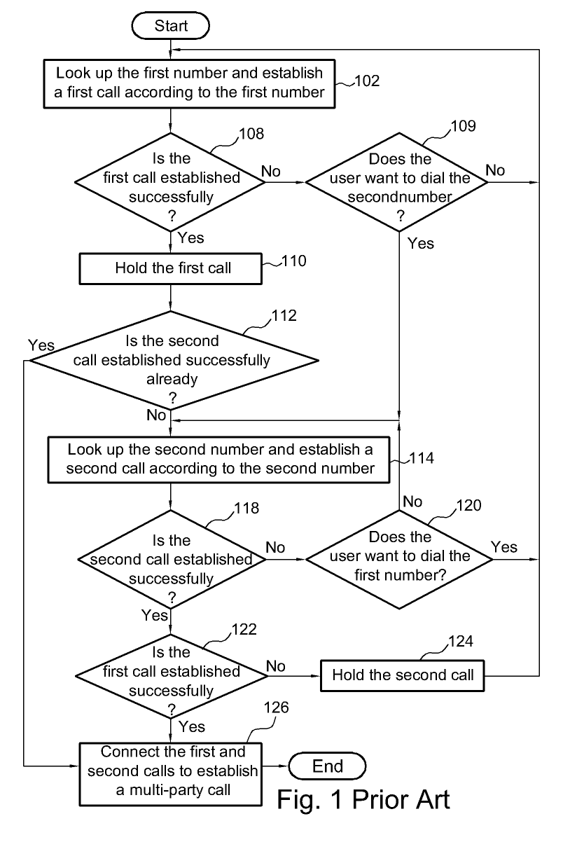

FIG. 2 shows a mobile unit for efficiently establishing a multi-party call according to an embodiment of the present invention.

FIG. 3 shows a diagram of the on-line program inside the MMI of FIG. 2.

FIG. 4 shows a brief flowchart for establishing the multi-party call of the mobile unit 200 in FIG. 2.

FIG. 5 shows a detailed flowchart of step 340 in FIG. 4.

FIG. 6 shows a detailed flowchart of step 350 in FIG. 4.

FIG. 7 shows a detailed flowchart of step 360 in FIG. 4.

### DETAILED DESCRIPTION

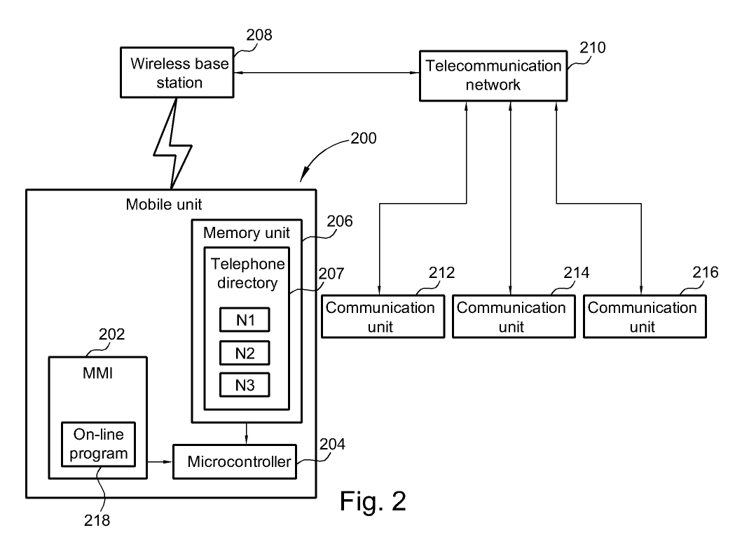

Please refer to FIG. 2. FIG. 2 is a mobile unit for efficiently establishing a multi-party call according to an embodiment of the present invention. In this embodiment, the mobile unit 200 such as a mobile phone comprises a Man-Machine Interface (MMI) 202, a microcontroller 204 and a memory unit 206. The mobile unit 200 is wirelessly communicated to a base station 208 and the base station 208 is further coupled to a telecommunications network 210. The microcontroller 204 is utilized to automatically establish, hold and connect each call. The MMI 202 is utilized to apply an operation interface for a user. The memory unit 206 stores a telephone directory 207 for recording each telephone number of the multi-party call in communication units 212, 214 and 216. In this embodiment, there are three communication units 212, 214 and 21 6 coupled to the telecommunications network 210 in FIG. 2. The communication units may be wireless units or wired units. There are on-line programs 218 in the mobile unit 200 and each of the communication units 212, 214 and 21 6 for showing the on-line status of the multi-party call and showing the users the present on-line status. The present invention does not limit the number of communication units in the multi-party call to three. For example, the number of communication units in the multi-party call can be five. Communication units 212, 214 and 216 can be telephones or mobile phones.

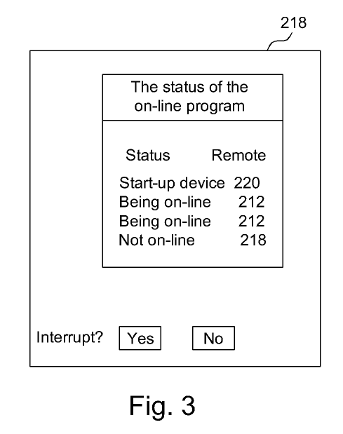

The multi-party call is started from the mobile unit 200. The microcontroller 204 sequentially dials numbers in the telephone directory 207, and automatically establishes, connects and holds each call in the communication units 212, 214 and 216. When any communication unit is connected, the on-line programs 218 of the remote mobile unit are either started or updated to show the connecting status. As shown in FIG. 3, the status of the on-line program 218 in the MMI 202 is shown. The mobile unit 200 starts the multi on-line procedure and the on-line program 218 in the same time. When the communication unit 212 is connected successfully, the communication unit 212 starts its on-line program 218. As shown in FIG. 3, when the communication unit 214 is connected successfully, it starts the on-line program 218 of the communication unit 214 and updates the on-line programs 218 of the mobile unit 200 and communication unit 212 at the same time.

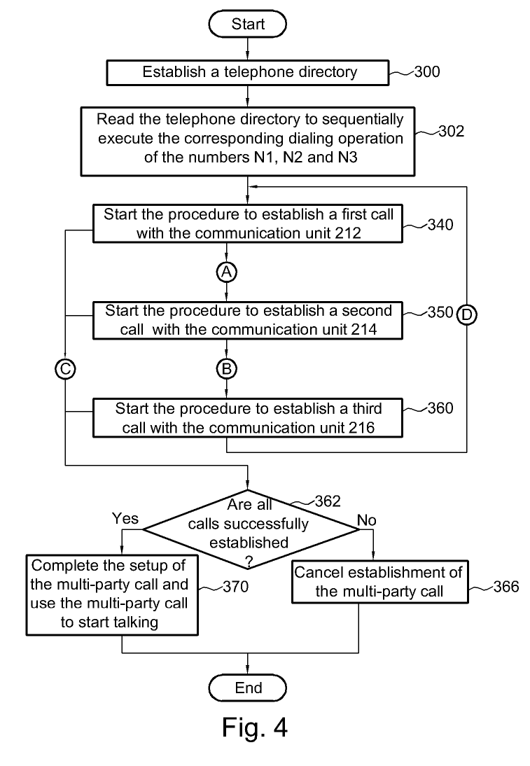

When the mobile unit 200 starts a multi-party call, every on-line program 218 of the corresponding communication units generates a notice signal to tell all the communication units that a multi-party call has been started, and this notice signal can be a ring tone or a animation message showing on display. As shown in FIG. 2, after all calls to be established, connected and held have been completed, the mobile unit 200 can start the multi-party call allowing voice exchange between the communication units 212, 214, 216 and 200. Please refer to FIG. 4. FIG. 4 is a brief flowchart showing establishment of the multi-party call of the mobile unit 200 in FIG. 2. The procedure for establishing the multi-party call of the mobile unit 200 includes:

Step 300: Establish a telephone directory 207 in a memory unit 206. The telephone directory 207 comprises a plurality of numbers N1, N2 and N3, wherein the number N1 corresponds to the communication unit 212, the number N2 corresponds to the communication unit 214, and the number N3 corresponds to the communication unit 216.

Step 302: The microcontroller 204 reads the telephone directory 207 to sequentially execute the corresponding dialing operation of the numbers N1, N2 and N3.

Step 340: The mobile unit 200 starts the procedure to establish a first call with the communication unit 212.

Step 350: The mobile unit 200 starts the procedure to establish a second call with the communication unit 214.

Step 360: The mobile unit 200 starts the procedure to establish a third call with the communication unit 216.

Step 362: Are all calls successfully established? If yes, go to step 370. If no, go to step 366.

Step 366: Cancel establishment of the multi-party call.

Step 370: Complete the setup of the multi-party call and use the multi-party call to start talking.

In this embodiment, the mobile unit 200 tries to establish the needed multi-party call automatically according to the order of the numbers N1, N2 and N3 in the telephone directory 207. Therefore, after the first, second, and third calls corresponding to the communication units 212, 214 and 216 have been successfully and sequentially established, the mobile unit 200 can start the multi-party call. However, if the first, second, or third calls corresponding to the communication units 212, 214 and 216 can not be established because of a busy line or other reasons, the mobile unit 200 will use various kinds of mechanisms to solve the above problem; the operation is described below.

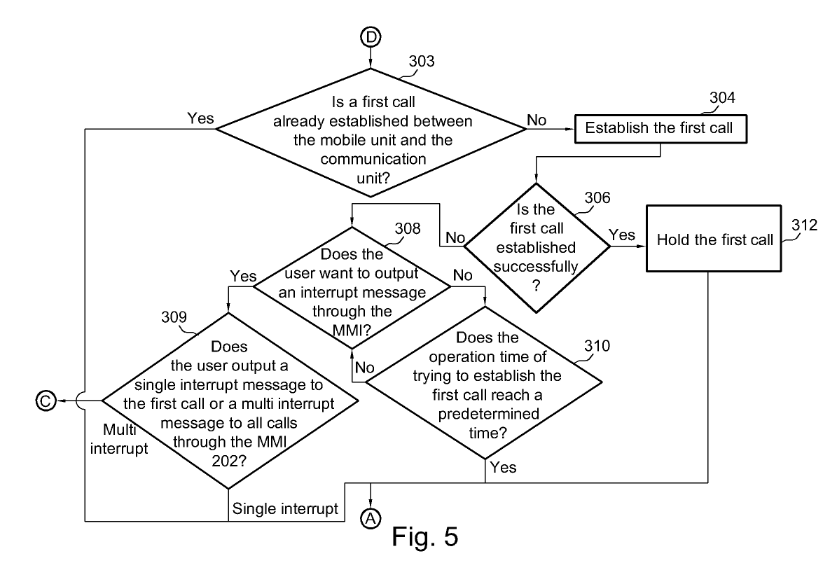

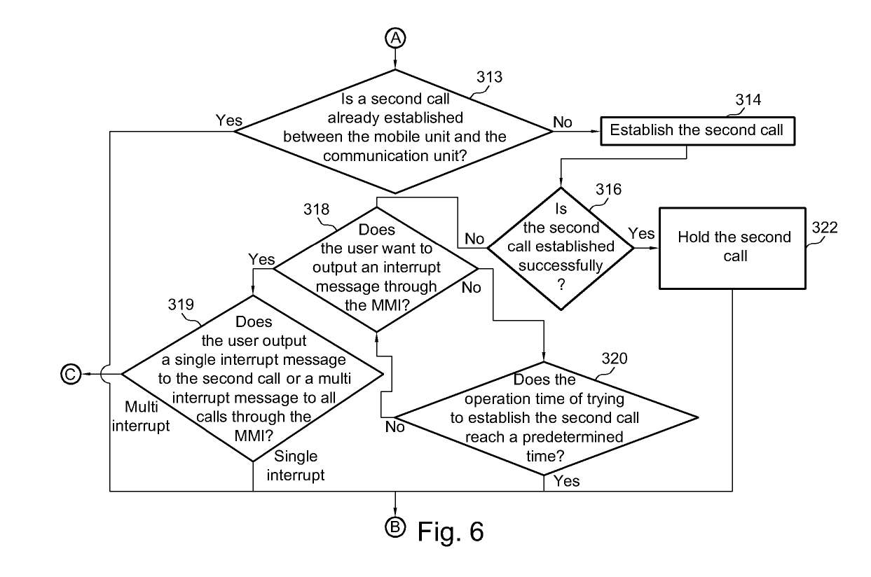

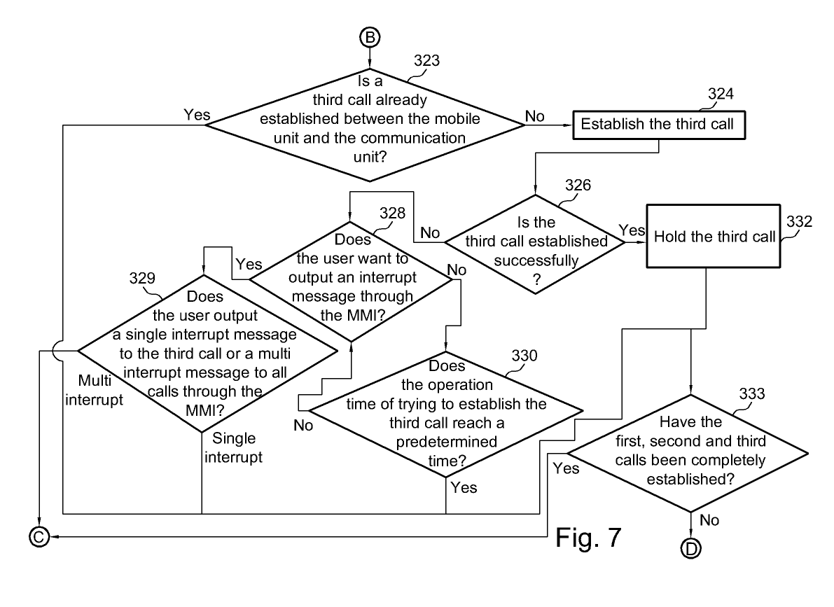

Please refer to FIG. 5, FIG. 6 and FIG. 7. FIG. 5 is a detailed flowchart of the procedure of step 340 in FIG. 4, FIG. 6 is a detailed flowchart of the procedure of step 350 in FIG. 4, and FIG. 7 is a detailed flowchart of the procedure of step 360 in FIG. 4. The procedure of establishing the first call includes the following steps:

Step 303: Is a first call already established between the mobile unit 200 and the communication unit 212? If yes, go to step 313. If no, go to step 306.

Step 304: Establish the first call.

Step 306: Is the first call established successfully? If successfully established, go to step 312. If failed, go to step 308.

Step 308: Does the user want to output an interrupt message through the MMI 202? If yes, go to step 309. If no, go to step 310.

Step 309: Does the user output a single interrupt message to the first call or a multi interrupt message to all calls through the MMI 202? If the user triggers the single interrupt message, go to step 313. If the user triggers the multi interrupt message, go to step 370.

Step 310: Does the operation time of trying to establish the first call reach a predetermined time? If yes, go to step 313. If no, go to step 308.

Step 312: Hold the first call.

The procedure of establishing the second call includes the following steps:

Step 313: Is a second call already established between the mobile unit 200 and the communication unit 212? If yes, go to step 323. If no, go to step 316.

Step 314: Establish the second call.

Step 316: Is the second call established successfully? If successfully established, go to step 322. If failed, go to step 318.

Step 318: Does the user want to output an interrupt message through the MMI 202? If yes, go to step 319. If no, go to step 320.

Step 31 9: Does the user output a single interrupt message to the second call or a multi interrupt message to all calls through the MMI 202? If the user triggers the single interrupt message, go to step 323. If the user triggers the multi interrupt message, go to step 370.

Step 320: Does the operation time of trying to establish the second call reach a predetermined time? If yes, go to step 323. If no, go to step 318.

Step 322: Hold the second call.

The procedure of establishing the third call includes the following steps:

Step 323: Is a third call already established between the mobile unit 200 and the communication unit 212? If yes, go to step 370. If no, go to step 326.

Step 324: Establish the third call.

Step 326: Is the third call established successfully? If successfully established, go to step 332. If failed, go to step 328.

Step 328: Does the user want to output an interrupt message through the MMI 202? If yes, go to step 329. If no, go to step 330.

Step 329: Does the user output a single interrupt message to the third call or a multi interrupt message to all calls through the MMI 202? If the user triggers the single interrupt message, go to step 333. If the user triggers the multi interrupt message, go to step 370.

Step 330: Does the operation time of trying to establish the third call reach a predetermined time? If yes, go to step 333. If no, go to step 328.

Step 332: Hold the third call.

Step 333: Have the first, second and third calls been completely established? If yes, go to step 370. If no, go to step 303.

In this embodiment, the telephone directory 207 established in the step 300 is stored in the memory unit 206 inside of the mobile unit 200 held by the user. If the user wants to start the multi-party call with other users in the same group afterwards, the user can utilize the telephone directory 207 inside the memory unit 206 rather than re-establish the telephone directory needed by the present invention. Please note that the memory unit 206 shown in FIG. 2 only shows the single telephone directory 207, which corresponds to a multi-party call group. However, the user can also store a plurality of telephone directories in the memory unit 206. The plurality of telephone directories corresponds to different multi-party call groups. The user can choose a specific telephone directory from the plurality of telephone directories to establish the wanted multi-party call; this limitation is also covered by the present invention.

Additionally, as described above, after the steps 306, 316 or 326 have successfully established the corresponding first, second or third calls, then the first, second, or third calls can be held. At this moment, the microcontroller 204 sends a prior hold message to the telecommunications network 210 to hold the successfully established first, second, or third calls. There are two types of prior hold message, which are defined in the technical specifications TS 02.84 and TS 03.84 in ETSI. One is a HOLD message, and the other is a FACILITY message. If the microcontroller 204 wants to hold the first call, the microcontroller 204 will automatically send a HOLD message to tell the telecommunications network 210 to hold the first call. When the first call is successfully established, the microcontroller 204 sends a notice message such as a voice, movie, or a text, to the communication unit 212, to tell the communication unit 212 that the multi-party call is being established at that moment, informing the user of the communication unit 212 to wait for a short time and not to hang up. In the same way, the above operation can be implemented when the second and third calls are established and held, and further discussion is omitted for the sake of brevity.

When the microcontroller 204 has established the calls with the communication units 212, 214 and 216 through the telecommunications network 210 and the wireless base station 208, it will receive a CONNECT message or a DISCONNECT message response from the telecommunications network 210 to determine whether the call being established has been successfully established. For example, if the CONNECT message is sent from the telecommunications network 210, it represents that the first call between the mobile unit 200 and the communication unit 212 has been successfully established. If the DISCONNECT message is sent from the telecommunications network 210, it represents that the communication unit 212 has actively hung up the first call between the mobile unit 200 and the communication unit 212. In this embodiment, the mobile unit 200 receives the DISCONNECT message because the corresponding call has not been successfully established. The CONNECT message and DISCONNECT message responses from the telecommunications network 210 are already defined in the technical specifications TS 02.84 and TS 03.84 in ETSI and further description is therefore omitted for the sake of brevity.

If any of the first, second, or third calls cannot be established in a predetermined time, the user can actively send an interrupt message through the MMI 202 to stop the call being established (Steps 310, 320, 330). For example, in step 316, the microcontroller 204 tries to establish the second call according to the order of the numbers N1, N2 and N3 in the telephone directory 207. According to the procedure of the technical specification TS 04.84 in ETSI, the microcontroller 202 requests the telecommunications network 210 through the wireless base station 208 to establish the second call of the communication unit 214 at this time. The telecommunications network 210 then begins to deal with a series of corresponding actions, and sends a message such as the CONNECT message through the wireless base station 208 to the microcontroller 204 after the telecommunications network 210 has finished dealing with the series of corresponding actions. In some situations such as the communications unit 214 being busy or not booting, meaning the telecommunications network 210 does not respond with the CONNECT message to the microcontroller through the wireless base station 208 for a long time, the user can actively send an interrupt message through the present invention MMI 202 at this time to make the microcontroller 202 give up waiting for a response from the telecommunications network 210, and go directly to the next step, Step 323 or Step 370. There are two kinds of interrupt outputted from the MMI 202. One is a single interrupt message, and the other is a multi interrupt message. The user can operate the MMI 202 to choose either kind of interrupt message to actively interrupt the procedure of establishing the second call through the keys of the mobile unit 200. In this embodiment, the difference between the single and multi interrupt messages are that if any other follow-up calls exist, the single interrupt message only interrupts the establishment of the second call, not further calls, whereas the multi interrupt message not only interrupts the establishment of the second call, but also stops the establishment of any follow-up calls.

As mentioned above, if the telecommunications network 210 sends the CONNECT message, it represents that one of the first, second, or third calls is successfully established. If the first call is successfully established in Step 306, then Step 312 only holds the first call and does not connect the first call because the first call is the only call to have been established in the multi-party call. When the second call is established in Step 316, the microcontroller 204 holds the second call and also actively sends a FACILITY message comprising a build multi-party command to the telecommunications network 210 to request the telecommunications network 210 to connect the successfully established second call with the first call already held to make the multi-party call (Step 322).

As in the above description, when the third call has successfully been established in Step 326, the microcontroller 204 holds the third call and also actively sends another FACILITY message comprising a build multi-party command to the telecommunications network 210 to request the telecommunications network 210 to connect the successfully established third call with the first and second calls already held to update the multi-party call (Step 322).

Additionally, in Steps 310, 320 or 330, if the user triggers the single interrupt message to cancel establishment of the present call, the mobile unit 200 finishes dialing a last number such as number N3 in the telephone directory 107. Then, because corresponding calls of some numbers have not been established yet, the microcontroller 204 returns to Step 303 to restart the procedure of establishing the first, second, or third calls not being successfully established until all of the calls have been successfully established (Step 333) or until the user triggers the multi interrupt message (Steps 310, 320, or 330).

Compared with the prior art, the present invention mobile unit and method for efficiently establishing a multi-party call actively orders the telecommunications network to establish the multi-party call through the microcontroller in the mobile unit. The microcontroller sequentially dials numbers in the telephone directory of the mobile unit, establishes, connects and holds the call. After the last call has successfully been established, connected and held, the needed multi-party call has been established. Additionally, the mobile unit further comprises an MMI. The user can send the interrupt message actively through the MMI to make the microcontroller give up attempting to establish a call. Because the present invention mobile unit and method for efficiently establishing a multi-party call can actively establish the multi-party call, it reduces operation time and saves the user the inconvenience of establishing the multi-party call themselves, thereby allowing the multi-party call function to be applied in daily life.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for establishing a multi-party call for a mobile unit, the mobile communicating with a base station, the base station coupled to a telecommunications network, the method comprising:
(A) establishing a telephone directory, the telephone directory comprising at least a first number and a second number, the first number corresponding to a first communication unit, the second number corresponding to a second communication unit, and the first and second communication units connect to the telecommunications network;
(B) sequentially dialing numbers in the telephone directory for establishing a first call to the first communication unit, if the first call is successfully established, hold the first call;
(C) establishing a second call to the second communication unit; and
(D) connecting the first and second calls for establishing the multi-party call if the second call is successfully established.

2. The method of claim 1, the step (B) further comprising: the mobile unit automatically sending a hold instruction to the telecommunications network to hold the first call.

3. The method of claim 2, the step (B) further comprising:
starting an on-line program inside the first communication unit for monitoring an on-line status inside the telephone directory of the mobile unit.

4. The method of claim 3, the step (D) further comprising:
updating the on-line status of the on-line program.

5. The method of claim 1, the step (B) further comprising:
establishing a notice message;
sending the notice message to the first communication unit when the first call is successfully established.

6. The method of claim 5, wherein the notice message could be a voice, movie or a text.

7. The method of claim 1 further comprising: outputting an interrupt message to stop establishing the first call or the second call.

8. The method of claim 7, wherein the mobile unit utilizes a Man-Machine Interface (MMI) to send the interrupt message.

9. The method of claim 1, wherein the first number is in front of the second number in the telephone directory, the method further comprising executing the step (C) if the first call can not be established in a predetermined time.

10. The method of claim 9, further comprising: establishing the first call if the second call is successfully established or the second call cannot be established successfully in the predetermined time.

11. The method of claim 10, wherein the second number is the last number in the telephone directory.

12. A mobile unit for establishing a multi-party call, the mobile unit communicating to a base station, the base station coupled to a telecommunications network, the mobile unit comprising:
a memory unit for storing a telephone directory wherein the telephone directory at least records a first number of a first communication unit and a second number of a second communication unit; and
a microcontroller coupled to the memory unit for sequentially dialing numbers in the telephone directory for establishing a first call to the first communication unit and establishing a second call to the second communication unit, wherein if the first and second calls are successfully established, the microcontroller requesting the telecommunications network to hold the first call and connecting the first and second calls to establish the multi-party call.

13. The mobile unit of claim 12, the microcontroller automatically sending a hold instruction to the telecommunications network to hold the first call.

14. The mobile unit of claim 12, the mobile unit further comprising:
a Man-Machine Interface (MMI) ; and
an on-line program for showing an on-line status of the telephone directory through the Man-Machine Interface (MMI).

15. The mobile unit of claim 14, wherein the on-line program sends a notice message when the mobile unit establishes the multi-party call.

16. The mobile unit of claim 15, wherein a first on-line program inside the first communication unit is started when the first call is successfully established, and statuses of the on-line program and the first on-line program are both updating at the same time.

17. The mobile unit of claim 12, wherein the microcontroller is further utilized to establish a notice message, and send the notice message to the first communication unit when the first call is successfully established.

18. The mobile unit of claim 17, wherein the notice message could be a voice, movie or a text.

19. The mobile unit of claim 12, wherein the microcontroller can send an interrupt message to stop establishing the first call or the second call.

20. The mobile unit of claim 12, wherein the first number is in front of the second number in the telephone directory, and the first call stops being established and the second call continues to be established if the microcontroller can not establish the first call in a predetermined time.

21. The mobile unit of claim 20, wherein the first call is established to the first communication unit if the second call is successfully established or the second call can not be successfully established in the predetermined time.

22. The mobile unit of claim 21, wherein the second number is the last number in the telephone directory.
